(19) United States
(12) Patent Application Publication
(10) Pub. No.: US 2016/0272119 A1
(43) Pub. Date: Sep. 22, 2016

(54) IMAGE PROJECTING DEVICE AND DRIVING SUPPORT DEVICE

(71) Applicant: TOYOTA JIDOSHA KABUSHIKI KAISHA, Toyota-shi, Aichi (JP)

(72) Inventor: Yoko ISHIGURO, Toyota-shi (JP)

(73) Assignee: TOYOTA JIDOSHA KABUSHIKI KAISHA, Toyota-shi, Aichi (JP)

(21) Appl. No.: 15/037,980

(22) PCT Filed: Feb. 18, 2015
(86) PCT No.: PCT/JP2015/054467

§ 371 Date: May 19, 2016

(30) Foreign Application Priority Data
Feb. 26, 2014 (JP) 2014-036047

(51) Int. Cl. B60R 1/00; H04N 9/31

(52) U.S. Cl. CPC B60R 1/00; H04N 9/3141; B60R 2300/202; B60R 2300/105

(57) ABSTRACT

An image projecting device and a driving support device, that can suppress light from a projecting unit heading toward eyes of a vehicle occupant, are provided. An image projecting device that structures a visual information supplementing device has: a projector that is disposed at a side opposite a cabin with respect to a roof head lining, and that projects an image through an opening, that is formed in the roof head lining, toward a vehicle cabin interior; and an erect wall that is a concealing structure that conceals the opening from a field of view of a driver.

### TECHNICAL FIELD

The present disclosure relates to an image projecting device and a driving support device.

### BACKGROUND ART

There is known a technique of capturing, by a dead angle imaging camera, the dead angle region created by a pillar, and projecting and displaying, on the inner side of the pillar, an image that corresponds to the exterior view of this dead angle region (see, for example, Japanese Patent Application Laid-Open (JP-A) No. 2009-083764). Further, there is known a technique of disposing a projector, that projects an image toward a pillar, within an instrument panel (see, for example, JP-A No. 2005-184225).

### SUMMARY OF INVENTION

### Technical Problem

By the way, in a structure that projects light from a projector onto a projected-on surface, there is room for improvement from the standpoint of suppressing light from the projector disturbing the field of view of a vehicle occupant.

An object of the present disclosure is to provide an image projecting device and a driving support device that can suppress light from a projecting unit heading toward the eyes of a vehicle occupant.

### Solution to Problem

An image projecting device relating to a first aspect comprises: a projecting unit that is disposed at a side opposite a vehicle cabin with respect to an interior fitting part of a vehicle, and that projects an image toward a vehicle cabin interior through an opening formed in the interior fitting part; and a concealing structure that conceals the opening from a field of view of a vehicle occupant.

In this image projecting device, (at least a portion of) the image that the projecting unit projects passes through the opening formed in the interior fitting part, and is guided to the vehicle cabin, and is projected on the projected-on surface that is provided within the vehicle cabin for example. Here, the opening that is formed in the interior fitting part, i.e., the entrance of the projected image into the vehicle cabin, is concealed from the field of view of the vehicle occupant by the concealing structure. Therefore, light from the projecting unit passing through the opening and heading toward the eyes of the vehicle occupant is prevented or effectively suppressed.

In this way, in the image projecting device of the first aspect, light from the projecting unit heading toward the eyes of the vehicle occupant can be suppressed.

In the above-described aspect, there may be a structure in which the projecting unit is disposed so as to be apart, toward the side opposite the vehicle cabin, from the opening.

In this image projecting device, (the light emitting portion of) the projecting unit is disposed, with respect to the opening, at the deep side of the placement space of the projecting unit as seen from the vehicle cabin side. Therefore, a portion of the projected image entering into the vehicle cabin is blocked by the interior fitting part. Due thereto, stray light, that has been projected from the projecting unit and is reflected by an interior surface of the vehicle cabin other than the projected-on surface, or the like, heading toward the eyes of the vehicle occupant is suppressed.

In the above-described aspect, there may be a structure in which the opening is formed such that, of an image projected by the projecting unit, an image other than an image that is to be projected onto a projected-on surface is blocked by the interior fitting part.

In this image projecting device, of the image that is projected by the projecting unit, that image that is not to be projected onto the projected-on surface is blocked by the wall, and does not enter into the vehicle cabin. On the other hand, of the image that is projected by the projecting unit, the image that is to be projected onto the projected-on surface passes-through the opening and is projected onto the projected-on surface. Due thereto, stray light, that is due to having been projected from the projecting unit and reflected by an interior surface of the vehicle cabin other than the projected-on surface, or the like, heading toward the eyes of the vehicle occupant is suppressed more effectively.

In the above-described aspect, there may be a structure in which the concealing structure is structured by the interior fitting part.

In this image projecting device, the concealing structure is structured in accordance with, for example, the orientation (posture, placement), the dimensions and shape, and the like of the wall at the interior fitting part which wall partitions the vehicle cabin and the placement space for the projecting unit. Thus, the concealing structure can be obtained without relying on additional parts.

In the above-described aspect, there may be a structure in which the interior fitting part has an erect wall that faces a side opposite a vehicle occupant side, and the concealing structure is structured by the opening being formed in the erect wall.

In this image projecting device, the erect wall itself, that faces the side opposite the vehicle occupant side at the interior fitting part, is concealed from the field of view of the vehicle occupant, and the concealing structure is structured by forming the opening in this erect wall. Therefore, light from the projecting unit heading toward the eyes of the vehicle occupant can be suppressed more effectively.

In the above-described aspect, there may be a structure further comprising a covering structure that covers at least a portion of the opening as seen from an outer side of the vehicle cabin.

In this image projecting device, because at least a portion of the opening is covered by the covering structure, (at least a portion of the light emitting portion of) the projecting unit is concealed with respect to the vehicle exterior. Therefore, light from the projecting unit heading toward the eyes of persons outside the vehicle is prevented or effectively suppressed.

In the above-described aspect, there may be a structure in which the projecting unit is disposed between a roof, and a ceiling material that serves as the interior fitting part and covers the roof from a vehicle cabin side, and the opening is formed in the ceiling material.

In this image projecting device, the projecting unit and the opening are disposed at the upper side with respect to the eyes of the vehicle occupant. Because the field of view (the sightlines) of a vehicle occupant (a person) are usually directed downward, light from the projecting unit, that is disposed above, heading toward the eyes of the vehicle occupant can be effectively suppressed.

A driving support device relating to a second aspect comprises: an imaging unit that captures a region that is a dead angle for a driver due to a vehicle structural part; and the image projecting device of any one of the above-described respective aspects, wherein the imaging unit outputs captured image information to the projecting unit, and the projecting unit is structured so as to project the image, that is captured by the imaging unit, toward a projected-on surface that is provided at the vehicle structural part.

In this driving support device, the image that has been captured by the imaging unit is projected toward the projected-on surface by the projecting unit of the image projecting device, and the image projected by the projecting unit is projected onto the projected-on surface. This projected image is seen by the driver who is a vehicle occupant. Because the concealing structure is provided at the image projecting device, light from the projecting unit heading toward the eyes of the driver is prevented or effectively suppressed.

In the above-described structure, there may be a structure in which the projected-on surface is provided at an entire region in a transverse direction, when viewed from the vehicle occupant, of a front pillar that serves as the vehicle structural part, and the opening of the image projecting device is formed such that, of an image projected by the projecting unit, an image other than an image that is to be projected onto the projected-on surface is blocked by the interior fitting part.

In this driving support device, because the projected-on surface is provided so as to extend over the entire width of the front pillar as seen from the driver, this driver can see the image of the dead angle region and the actual view without breaks. Here, of the image that is projected by the projecting unit, the image that is not to be projected onto the projected-on surface is blocked by the interior fitting part, and does not enter into the vehicle cabin. On the other hand, of the image that is projected by the projecting unit, the image that is to be projected onto the projected-on surface passes-through the opening and is projected onto the projected-on surface. Due thereto, stray light, that is due to having been projected from the projecting unit and reflected by an interior surface of the vehicle cabin other than the projected-on surface, or the like, heading toward the eyes of the vehicle occupant is suppressed.

In the above-described aspect, there may be a structure in which the projecting unit of the image projecting device is disposed between a front portion of a roof, and a ceiling material that serves as the interior fitting part and covers the roof from a vehicle cabin side, and the opening of the image projecting device is formed in an erect wall that faces a vehicle front side at the ceiling material, and at least a portion of the opening is covered by an inner mirror when the vehicle cabin is viewed from a front side.

In this driving support device, the image, that is projected from the projecting unit that is disposed between the roof and the ceiling material, passes through the opening formed in the erect wall of the ceiling material and is projected onto the projected-on surface of the front pillar. In this driving support device, because at least a portion of the opening is covered from the front by the inner mirror, (at least a portion of the light emitting portion of) the projecting unit is concealed with respect to the vehicle front exterior. Thus, the light from the projecting unit heading toward the eyes of persons at the vehicle exterior is prevented or effectively suppressed.

### Advantageous Effects of Invention

As described above, the image projecting device and the driving support device relating to the present disclosure have the excellent effect of being able to suppress light from a projecting unit heading toward the eyes of a vehicle occupant.

### BRIEF DESCRIPTION OF DRAWINGS

FIG. 1 is a side sectional view that schematically shows main portions of a visual information supplementing device relating to an embodiment.

FIG. 2 is a plan sectional view that schematically shows main portions of the visual information supplementing device relating to the embodiment.

FIG. 3 is a perspective view that schematically shows the opening shape of the visual information supplementing device relating to the embodiment.

FIG. 4 is a perspective view that schematically shows the overall structure of the visual information supplementing device relating to the embodiment.

FIG. 5 is a plan view that schematically shows the overall structure of the visual information supplementing device relating to the embodiment.

FIG. 6 is a side sectional view that schematically shows various modified examples of the visual information supplementing device.

### DESCRIPTION OF EMBODIMENTS

A visual information supplementing device 10, that serves as an example of a driving support device to which an image projecting device relating to an embodiment of the present disclosure is applied, is described on the basis of the drawings. Note that arrow FR, arrow UP, arrow RH and arrow LH that are marked appropriately in the respective drawings indicate, respectively, the frontward direction, the upward direction, and the rightward direction and the leftward direction in a case of facing in the frontward direction of an automobile to which the visual information supplementing device 10 is applied. Hereinafter, when simply longitudinal, vertical and left-right directions are used, they mean the longitudinal of the vehicle longitudinal direction, the vertical of the vehicle vertical direction, and the left and the right in a case of facing in the frontward direction, unless otherwise indicated.

[General Structure of Vehicle]

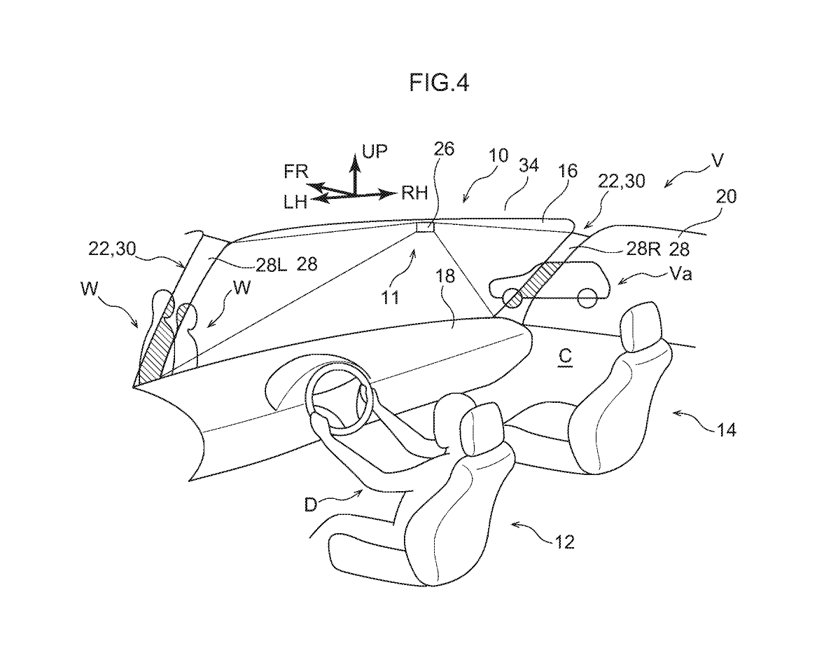

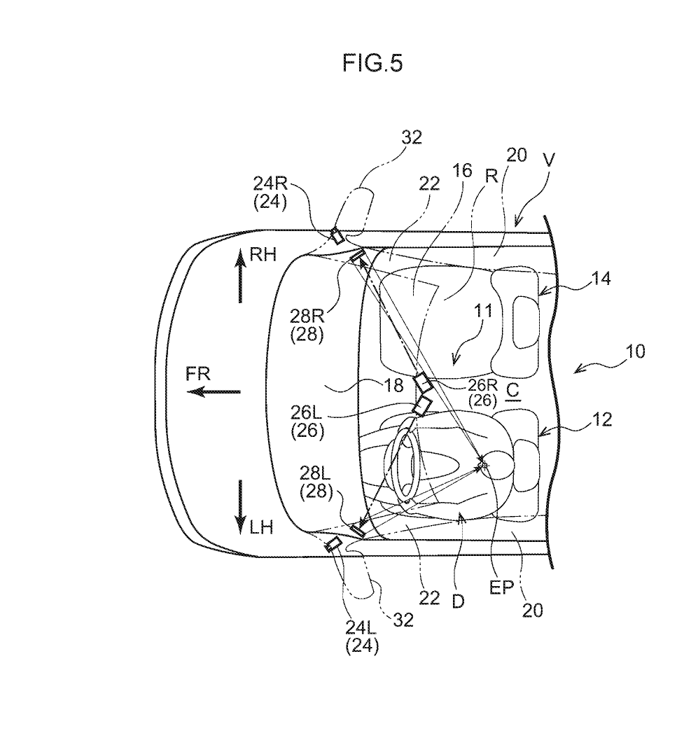

As shown in FIG. 4 and FIG. 5, a driver's seat 12 and a front passenger's seat 14 are provided within a cabin C that is the vehicle cabin of an automobile V that serves as a vehicle to which the visual information supplementing device 10 is applied. In this embodiment, the driver's seat 12 is disposed at the left side with respect to the vehicle transverse direction center of the automobile V. A windshield glass 16 and an instrument panel 18 are disposed in front of the driver's seat 12. Further, side window glasses 20 are respectively disposed at the vehicle transverse direction outer sides of the driver's seat 12 and the front passenger's seat 14.

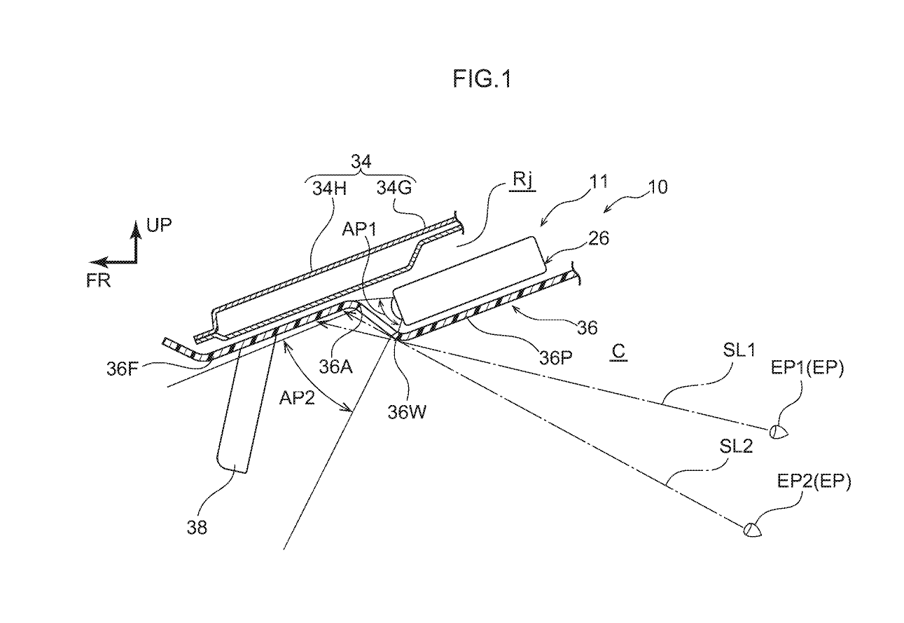

Further, front pillars 22, that serve as examples of vehicle structural parts, (and unillustrated door frames) are disposed between the windshield glass 16 and the left and right side window glasses 20. These left and right front pillars 22, together with a roof header 34H (see FIG. 1) and a cowl portion (not illustrated), structure the window frame at which the field of view is ensured by the windshield glass 16. Further, the left and right front pillars 22, together with door frames of side doors and the like that are respectively not illustrated, structure window frames at which the field of view is ensured by the side window glasses 20. These left and right front pillars 22 can be considered to be skeleton (window frame) members that create (give rise to) dead angles with respect to the vehicle occupant seated in the driver's seat 12, i.e., a driver D.

[Overall Structure of Visual Information Supplementing Device]

The visual information supplementing device 10 is structured so as to cause the driver D to see visual information of the vehicle outer side regions that become dead angles to the driver D due to the front pillars 22. Concrete description is given hereinafter.

The visual information supplementing device 10 is structured to include CCD cameras 24 that serve as image capturing unit, and an image projecting device 11. Further, the image projecting device 11 is structured to include projectors 26 that serve as projecting unit, and screens 28 that form projected-on surfaces at the front pillars 22. Note that the CCD cameras 24, the projectors 26, and the screens 28 are respectively provided as left/right pairs. In the following description, when differentiating between the CCD cameras 24, the projectors 26 and the screens 28 at the left and the right, “L” is added to the end of the reference numeral of that on the left side, and “R” is added to the end of the reference numeral of that on the right side.

The CCD camera 24L at the left side is disposed so as to face in the sightline direction from the driver D toward the left side front pillar 22 side, and captures the region that is obliquely forward and to the left of the cabin C, and outputs image information of the captured image to the projector 26L. The CCD camera 24R at the right side is disposed so as to face in the sightline direction from the driver D toward the right side front pillar 22 side, and captures the region that is obliquely forward and to the right of the cabin C, and outputs image information of the captured image to the projector 26R. The left and right CCD cameras 24 are disposed, for example, within door mirror devices 32 or within the lower portions of the front pillars 22, at the sides corresponding to the left and the right respectively.

Image information is inputted wirelessly or by wires from the CCD camera 24L to the projector 26L at the left side, and the projector 26L at the left side projects an image, that is based on this image information, toward a screen 28L. Image information is inputted wirelessly or by wires from the CCD camera 24R to the projector 26R at the right side, and the projector 26R at the right side projects an image, that is based on this image information, toward a screen 28R. Placement of the left and right projectors 26 is described later.

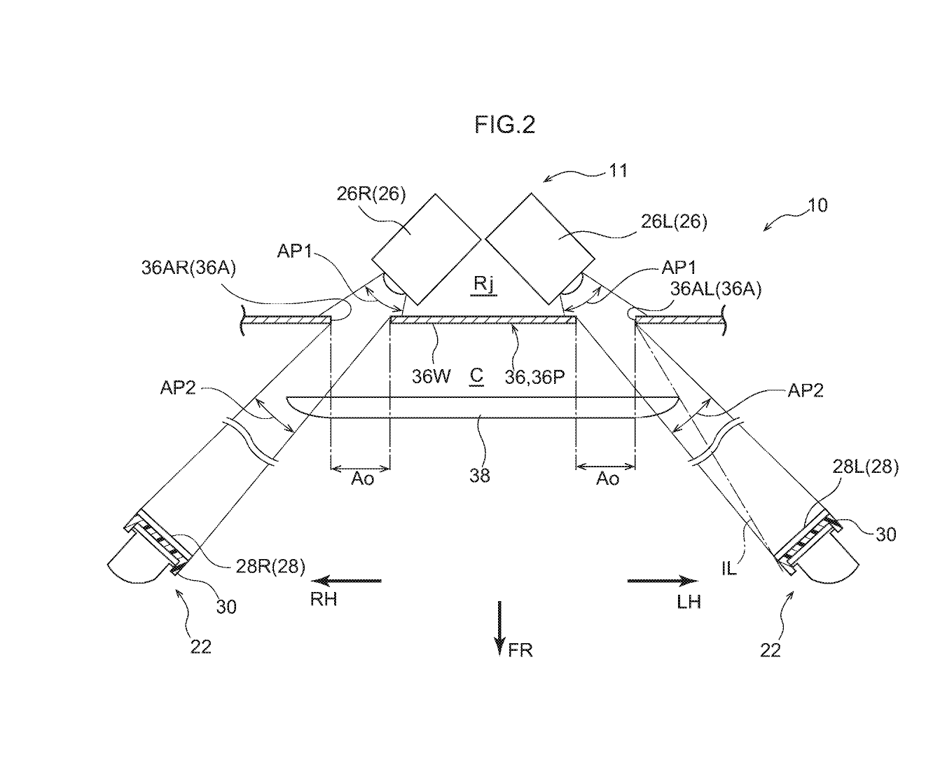

The images that the corresponding projectors 26 project are projected onto the left and right screens 28. As shown in FIG. 2, these screens 28 are provided at the surfaces of pillar garnishes 30 that serve as examples of interior finishing parts and that structure the front pillars 22, or these screens 28 structure the surfaces of the pillar garnishes 30 (are formed integrally with the surfaces). In this embodiment, the screen 28L at the left side is provided at the surface of the pillar garnish 30 at the left side, and the screen 28R at the right side is provided at the surface of the pillar garnish 30 at the right side.

Further, in this embodiment, the screen 28 is provided over the entire region in the transverse direction at the front pillar 22 including the pillar garnish 30, when viewed from the driver D. In other words, the screen 28 is made to be a structure that occupies a range extending over the entire width of the front pillar 22 as seen from the driver D (overlaps from a transverse direction one end to the other end of the front pillar 22). Due thereto, as shown in FIG. 4, the visual information supplementing device 10 is structured so as to cause the driver D to view the image of the dead angle region and the actual view without breaks.

As shown in FIG. 4, the screen 28L at the left side reaches from a vicinity of the upper end of the pillar garnish 30 to a vicinity of the lower end, and is disposed so as to occupy a wide range of that pillar garnish 30 in the vertical direction. The screen 28R at the right side reaches from a vicinity of the upper end of the pillar garnish 30 to a vicinity of the lower end, and is disposed so as to occupy a wide range of that pillar garnish 30 in the vertical direction.

[Structure of Main Portions]

The placement of the projectors 26 is described hereinafter. Note that, because the placement (design concept) of the left and right projectors 26L, 26R is similar, in the following description, the projector 26 will be described in the singular without distinguishing between the left and right projectors 26L, 26R.

As shown in FIG. 1, the projector 26 is disposed between a roof 34 that structures the vehicle body of the automobile V, and a roof head lining 36 that covers the roof 34 from the cabin C side. Namely, the projector 26 is disposed at the side opposite the cabin C side, with the roof head lining 36 sandwiched therebetween. In this embodiment, the projector 26 is disposed between the roof head lining 36, and the roof header 34H that forms the front end of the roof 34 and a general portion 34G (roof panel) of the roof 34. Here, the roof head lining 36 corresponds to an interior fitting part and a ceiling material. More concrete description is given hereinafter.

A protruding portion 36P, that protrudes-out downward so as to widen the facing space where the roof head lining 36 faces the roof header 34H and the general portion 34G of the roof 34 in the vertical direction, is formed at the front end side of the roof head lining 36. Although not illustrated, the protruding portion 36P is disposed at the vehicle transverse direction central portion. The left and right projectors 26L, 26R, are disposed within a placement space Rj (a space that is partitioned-off from the cabin C) that is formed by the protruding portion 36P of the roof head lining 36 and the roof 34.

Further, a front wall 36W, that forms the front end of the protruding portion 36P of the roof head lining 36, is an erect wall that extends in the vertical direction as seen in a side sectional view. In this embodiment, the front wall 36W is inclined slightly forward with respect to the vertical direction. Further, the front wall 36W of the protruding portion 36P of the roof head lining 36 is a wall that, at further toward the front side than a visual point EP of the driver D, faces toward the front side, i.e., the side opposite the driver D side (the vehicle occupant side).

Therefore, the front wall 36W is a structure that cannot be seen from the driver D. For example, neither of sightline SL1, that is directed toward the front end of the protruding portion 36P from visual point EP1 of a vehicle occupant of a large physique shown in FIG. 1, or sightline SL2, that is directed toward the front end of the protruding portion 36P from visual point EP2 of a vehicle occupant of a large physique, is directed toward the front wall 36W. In other words, the angle, at the acute angle side, of the front wall 36W with respect to the horizontal direction (the longitudinal direction) is greater than the angles, at the acute angle sides, that the sightlines SL1, SL2 form with respect to the horizontal direction.

An opening 36A, through which the image projected from the projector 26 passes, is formed in this front wall 36W. Due to this opening 36A being formed in the front wall 36W, there is a structure in which the region, at which the projected image (there are cases in which this is called “projected light” in the following description) of the projector 26 enters into the cabin C, cannot be seen from the driver D. By providing the front wall 36W that is an erect wall at the protruding portion 36P and by forming the opening 36A in the front wall 36W in this way, a concealing structure that conceals this opening 36A from the field of view of the driver D (the vehicle occupant) is structured.

Further, the projector 26 is disposed so as to be apart, toward the side opposite the C side in the cabin projecting direction, from the opening 36A of the front wall 36W. In other words, the light emitting portion of the projector 26 is disposed so as to be apart, toward the deep side of the placement space Rj, from the plane of opening of the opening 36A (an imaginary plane that runs along the front surface of the front wall 36W). Due thereto, a portion of the projected light of the projector 26 does not pass-through the opening 36A, and the emitting thereof into the cabin C is blocked by the front wall 36W. Further, the shape of the opening 36A corresponds to the shape of the screen 28.

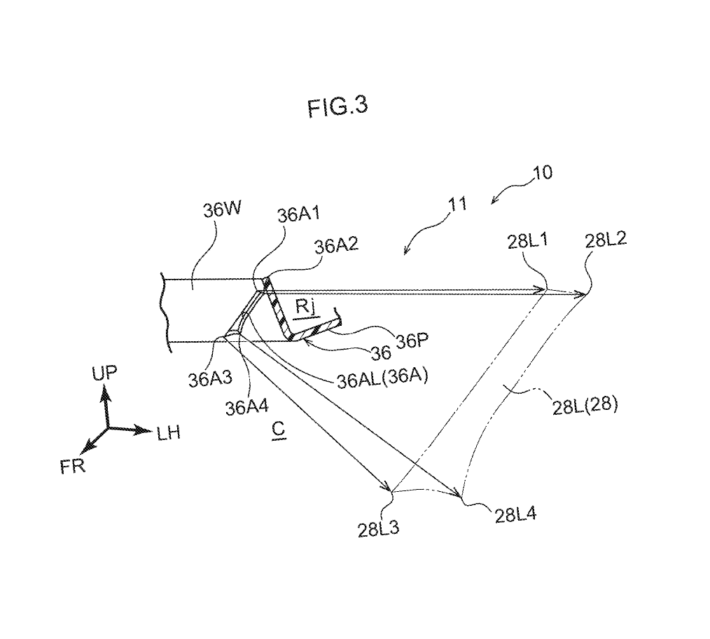

More concretely, as schematically shown in FIG. 3, there is a structure in which the projected lights, that pass through four corners 36A1˜36A4 of an opening 36AL that is formed in a substantially rectangular shape, are projected onto corresponding corners 28L1˜28L4 of the screen 28L that is formed in a substantially rectangular shape. Although not illustrated, in the same way as the opening 36AL at the left side, the shape (the relationship of the four corners) of an opening 36AR at the right side as well is determined in accordance with the shape of the screen 28R at the right side.

Therefore, the opening 36A is formed such that, of the image (projection range Ap1 shown in FIG. 1 and FIG. 2) projected by the projector 26, the image other than the image (projection range Ap2) that is to be projected onto the screen 28 is blocked by the front wall 36W. To describe further, the projector 26 is a structure that projects an image of a range that is wider than the image that is to be projected onto the screen 28, and the image, that is other than the image that is projected from this projector 26 and is to be projected onto the screen 28, is blocked by the front wall 36W. Due thereto, as shown schematically in FIG. 2 and FIG. 3, there is a structure in which, of the image that is projected from the projector 26, only the image that is to be projected onto the screen 28 passes through the opening 36A.

Further, the roof head lining 36 has a front portion 36F, that projects-out further toward the front side than the front wall 36W and that reaches the front end of the roof 34, and an inner mirror 38 is mounted to this front portion 36F. Note that the inner mirror 38 may be structured so as to be mounted to the upper end portion of the windshield glass 16.

Further, as shown schematically in FIG. 2, the left and right openings 36A (hereinafter, there are cases in which the opening 36A at the left side is called the opening 36AL and the opening 36A at the right side is called the opening 36AR) are covered by the inner mirror 38 as seen from the front, i.e., the outer side, with respect to the cabin C. A covering structure that covers at least a portion of the opening 36A as seen from the outer side of the cabin C is thereby structured.

In this embodiment, the inner mirror 38 overlaps the entire widths in the vehicle transverse direction of respective opening ranges Ao of the left and right openings 36AL, 36AR as seen in a plan view. In this embodiment, the vehicle transverse direction end portions of the inner mirror 38 extend to as far as imaginary straight lines IL (only the left side is shown in FIG. 2) that connect the vehicle transverse direction outer side edge portions of the openings 36AL, 36AR and the vehicle transverse direction inner side edge portions of the front pillars 22. Further, as seen in a side view, the inner mirror 38 and the front portion 36F of the roof head lining 36 overlap the opening ranges (not illustrated) of the openings 36A over the entire heights thereof in the vertical direction.

[Operation]

Operation of the present embodiment is described next.

The driver D of the automobile V, to which the visual information supplementing device 10 that includes the image projecting device 11 is applied, drives the automobile V while checking safety on the basis of visual information that is seen through the windshield glass 16 and the left and right side window glasses 20.

Further, at the visual information supplementing device 10, the images captured by the left and right CCD cameras 24L, 24R are projected by the projectors 26, and are projected onto the left and right screens 28L, 28R. The images projected on the left and right screens 28L, 28R are viewed by the driver D. Namely, the visual information (external views) of the regions that are dead angles due to the left and right front pillars 22 are displayed as images on the screens 28 that are provided at the front pillars 22. Therefore, the driver D faces the direction that should be confirmed (the dead angle region), and can see the image that compensates for the dead angle region. Due thereto, as shown in FIG. 4 for example, even in a case in which pedestrians W or another vehicle Va exist in a vehicle outer side region that is a dead angle, the driver can notice (easily notice) the pedestrians W or the other vehicle Va.

Here, at the visual information supplementing device 10 and the image projecting device 11, the opening 36A that is formed in the roof head lining 36, i.e., the region of entry into the cabin C of the image projected from the projector 26, is concealed from the field of view of the driver D. Concretely, the opening 36A, that forms the region of entry into the cabin C of the image projected from the projector 26, is formed in the front wall 36W, that cannot be seen from the driver D (i.e., that faces the side opposite the driver D side), at the roof head lining 36. Therefore, the projected light that has passed through the opening 36A is prevented from heading toward the eyes of the driver D.

In this way, in the visual information supplementing device 10 and the image projecting device 11 relating to the present embodiment, light from the projector 26 heading toward the eyes of the driver D can be prevented or suppressed. Namely, at the visual information supplementing device 10 and the image projecting device 11, the vicinity of the opening 36A where the projected light is strong (the light density is high) can be concealed from the eyes of the driver D. Due thereto, the driver D being blinded by the light from the projector 26 is prevented or effectively suppressed.

Further, because the projector 26 is disposed so as to be apart, toward the side opposite the cabin C (i.e., toward the deep side of the placement space Rj), from the front wall 36W, i.e., the opening 36A, a portion of the image that is projected from the projector 26 is blocked by the front wall 36W and does not enter into the cabin C interior. Thus, for example, the generation of stray light (reflected light or glare), that enters the cabin C and that is reflected by the side window glass 20 or the like, is suppressed, and the driver D being blinded by stray light or feeling as if the view is obstructed is prevented or effectively suppressed.

In particular, due to the shape of the opening 36A being formed so as to correspond to the shape of the screen 28, the portion that is not to be projected onto the screen 28, of the projected image (the projection range Ap1) of the projector 26, is blocked by the front wall 36W and does not enter into the cabin C. Due thereto, generation of the aforementioned stray light is prevented or is markedly suppressed, and the driver D being blinded by stray light is prevented or effectively suppressed. On the other hand, the portion (the projection range Ap2), that should be projected onto the screen 28, of the projected image of the projector 26 passes-through the opening and enters into the cabin C, and is projected onto the screen 28. Thus, the function of causing the driver D to see an image that compensates for the dead angle region is achieved as described above.

Moreover, due to the shape of the opening 36A being formed so as to correspond to the shape of the screen 28 as described above, there is hardly any projection of the image from the projector 26 onto portions of interior surfaces of the cabin C other than the screen 28. Thus, the projected light (the projected image) from the projector 26 marring the design characteristics (the design) of the interior fittings of the cabin C is prevented or markedly suppressed.

Still further, at the visual information supplementing device 10 and the image projecting device 11, the front wall 36W (the protruding portion 36P) is provided at the roof head lining 36 itself that forms the placement space Rj of the projector 26, and the concealing structure is structured by forming the opening 36A in this front wall 36W. Namely, because the concealing structure is structured by forming the opening 36A in the front wall 36W that is directed (is set in a posture, is disposed) such that it cannot be seen from the driver D, the number of parts is small and the design characteristics are good as compared with, for example, a case of forming a concealing structure by additional parts.

Moreover, because the concealing structure and the placement space Rj are formed by the roof head lining 36 that is positioned above the head of the driver D, the design characteristics of the cabin C interior are good as compared with a structure in which the projector 26 is disposed within the cabin C. In particular, placing the projector 26 at the roof portion (the ceiling) is highly efficient in terms of space, and effects on the driver D and the other vehicle occupants (a cramped feeling or a feeling of strangeness) also are slight.

Moreover, at the visual information supplementing device 10 and the image projecting device 11, the projector 26 is disposed within the roof head lining 36 that is above the eyes (the visual points EP) of the driver D. Here, because the sightlines (the field of view) of the driver D generally are directed further downward than horizontal, it is difficult for the driver D to sense a feeling of strangeness even if a portion that is bright arises in a vicinity of the opening 36A at night or the like for example.

Further, here, at the visual information supplementing device 10 and the image projecting device 11, because the left and right openings 36AL, 36AR are covered by the inner mirror 38 as seen from the front, i.e., the outer side, with respect to the cabin C, (at least portions of the light emitting portions of) the projectors 26 are concealed with respect to the vehicle front exterior. Thus, the images (the lights) that are projected from the projectors 26 heading toward the eyes of a person positioned at the exterior of the automobile V, such as a vehicle occupant of another vehicle or a pedestrian or the like for example, is prevented or effectively suppressed. Namely, the vicinities of the openings 36A where the light density is high can be concealed from the eyes of persons positioned at the exterior of the vehicle. Due thereto, a person who is positioned at the exterior of the automobile V being blinded by the lights emitted from the projectors 26 is prevented or effectively suppressed. In particular, at the visual information supplementing device 10 and the image projecting device 11, the vehicle transverse direction end portions of the inner mirror 38 reach to as far as the imaginary straight lines IL that connect the vehicle transverse direction outer side edge portions of the openings 36AL, 36AR and the vehicle transverse direction inner side edge portions of the front pillars 22. Therefore, the images (the lights) that are projected from the projectors 26 heading toward the eyes of, for example, a person positioned in front of another automobile V, is prevented or effectively suppressed.

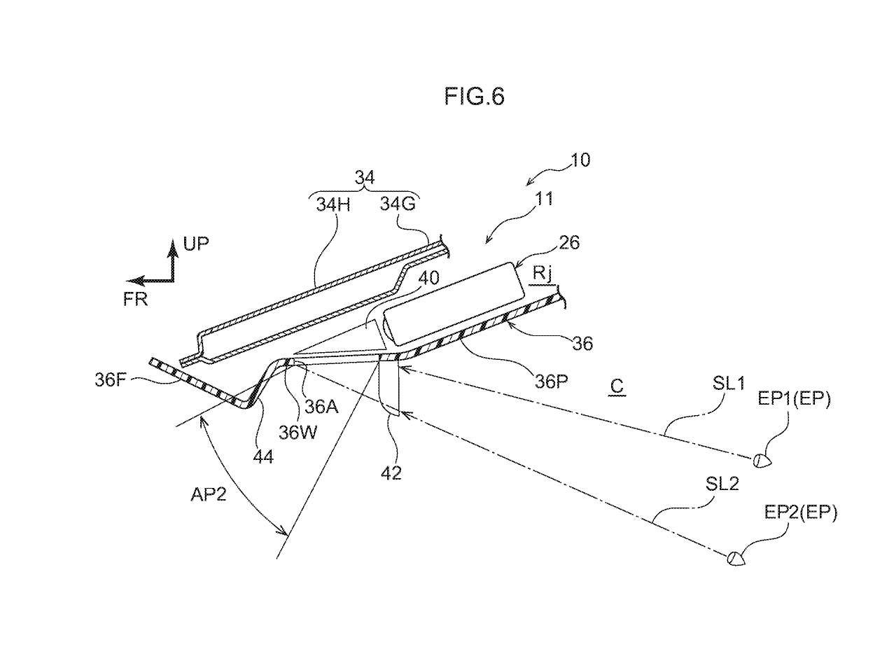

Note that the above-described embodiment illustrates an example that uses the front wall 36W of the roof head lining 36 as the concealing structure, and uses the inner mirror 38 as the covering structure. However, the present disclosure is not limited to this. For example, there may be the structure relating to the modified example that is shown in FIG. 6. Here, to further describe the structure of FIG. 6, the light emitted from the projector 26 is projected toward the screen 28 by being reflected by a mirror 40 that serves as a reflecting unit. Accordingly, in the present modified example, it can be considered that the projecting unit is structured by the projector 26 and the mirror 40. Note that there may be a structure in which the images that are to be projected onto the left and right screens 28L, 28R are emitted from the common projector 26, and the images are projected individually onto the screens 28L, 28R by different reflecting surfaces of the mirror 40.

In such a structure, the angle of the front wall 36W is near horizontal, and the opening 36A is disposed so as to be able to be seen from the visual points EP1, EP2. Here, the present modified example has, as the concealing structure, a projecting portion 42 that is mounted to the roof head lining 36 or is formed at the roof head lining 36. The concealing structure, that is such that the opening 36A cannot be seen from the driver D, is structured by this projecting portion 42.

The projecting portion 42 may be a part that is exclusively used as the concealing structure, or may be structured by, for example, a panel or the like at which a map lamp or a sunroof switch or the like are disposed. Note that a structure, that has the projecting portion 42 that serves as the concealing structure relating to this modified example, is not limited to application to a structure in which the projecting unit has the mirror 40.

Further, the present modified example has, as the covering structure, a lower projection 44 that is formed at the roof head lining 36 so as to project-out downward. Due thereto, the openings 36A (36AL, 36AR) can be formed and arranged regardless of limitations such as, for example, the size and placement of the inner mirror 38 or the like for example. Further, the covering structure may be structured by using, for example, a vehicle exterior information acquiring unit such as a camera for exterior imaging or a millimeter wave radar device or the like, instead of the inner mirror 38 or the lower projection 44. Structures that have covering structures relating to these modified examples are not limited to application to structures in which the projecting unit has the mirror 40 or structures that have the projecting portion 42 as the concealing structure.

Moreover, although the above-described embodiment and modified examples illustrate examples in which the projector 26 is disposed within the roof head lining 36, the present disclosure is not limited to this. For example, the projector 26 may be disposed at the side that is opposite the cabin C side with respect to another interior fitting part, such as within the instrument panel, within an overhead console, within the inner mirror, or the like.

Still further, although the above-described embodiment and modified examples illustrate examples in which the present disclosure is applied to the front pillar 22 that is an example of a vehicle structural part, the present disclosure is not limited to this, and the present disclosure can be applied to any vehicle structural part that forms a dead angle with respect to the driver D. Accordingly, for example, the present disclosure can be applied to a portion of or the entirety of a center pillar, a rear pillar, the instrument panel, or the like as a vehicle structural part, instead of or in addition to (either one of) the front pillars 22.

Further, the above-described embodiment and modified examples illustrate examples that are applied to the visual information supplementing device 10 that serves as a driving support device in which the image projecting device relating to the present disclosure projects a dead angle image onto a dead angle forming part. However, the present disclosure is not limited to this. It suffices for embodiments of the present disclosure to have a concealing structure in a structure that projects a captured image onto a projected-on surface, and, for example, there may be a structure in which an image in which the region at the rear of the vehicle at the time of reversing is captured, or an image in which the situation in the rear seat is captured, is projected onto the instrument panel or the like. Further, the present disclosure is not limited to a structure that projects, onto an interior fitting part, an image that has been captured by an imaging unit that is installed within that vehicle, and, for example, the present disclosure may be applied to a structure that projects, onto the instrument panel 18 or the windshield glass 16, map information or driving information (the vehicle speed or the like). Moreover, for example, the present disclosure may be applied to a structure that projects, onto an interior fitting part, the captured image of a camera that is on the road or that is set in another vehicle.

Moreover, although the above-described embodiment illustrates an example in which the CCD camera 24 is used as the imaging unit, the present disclosure is not limited to this and may utilize any imaging unit. Accordingly, for example, a CMOS camera or the like may be used instead of the CCD camera 24.

In addition, it goes without saying that the present disclosure can be implemented by being modified in various ways within a scope that does not depart from the gist thereof. Further, the disclosure of Japanese Patent Application No. 2014-036047 that was filed on Feb. 12, 2014 is, in its entirety, incorporated by reference into the present specification.

The relationships of correspondence between the reference numerals and the names of the respective portions that are used in the present specification are as follows.
10 visual information supplementing device (driving support device)
11 image projecting device
22 front pillar (vehicle structural part)
24 CCD camera (imaging unit)
26 projector (projecting unit)
28 screen (projected-on surface)
30 pillar garnish (front pillar, vehicle structural part)
24 roof
36 roof head lining (ceiling material, interior fitting part)
36A opening
36W front wall (erect wall, concealing structure)
38 inner mirror (covering structure)
42 projecting portion (concealing structure)
44 lower projection (covering structure)
C cabin (vehicle cabin)
D driver (vehicle occupant)

1: An image projecting device comprising:
a projecting unit that is disposed at a side opposite a vehicle cabin with respect to an interior fitting part of a vehicle, and that projects an image toward a vehicle cabin interior through an opening formed in the interior fitting part; and
a concealing structure that conceals the opening from a field of view of a vehicle occupant.

2: The image projecting device of claim 1, wherein the projecting unit is disposed so as to be apart, toward the side opposite the vehicle cabin, from the opening.

3: The image projecting device of claim 2, wherein the opening is formed such that, of an image projected by the projecting unit, an image other than an image that is to be projected onto a projected-on surface is blocked by the interior fitting part.

4: The image projecting device of claim 1, wherein the concealing structure is structured by the interior fitting part.

5: The image projecting device of claim 4, wherein
the interior fitting part has an erect wall that faces a side opposite a vehicle occupant side, and
the concealing structure is structured by the opening being formed in the erect wall.

6: The image projecting device of claim 1, further comprising a covering structure that covers at least a portion of the opening as seen from an outer side of the vehicle cabin.

7: The image projecting device of claim 1, wherein
the projecting unit is disposed between a roof, and a ceiling material that serves as the interior fitting part and covers the roof from a vehicle cabin side, and
the opening is formed in the ceiling material.

8: A driving support device comprising:
an imaging unit that captures a region that is a dead angle for a driver due to a vehicle structural part; and
the image projecting device of claim 1,
wherein the imaging unit outputs captured image information to the projecting unit, and the projecting unit is structured so as to project the image, that is captured by the imaging unit, toward a projected-on surface that is provided at the vehicle structural part.

9: The driving support device of claim 8, wherein
the projected-on surface is provided at an entire region in a transverse direction, when viewed from the vehicle occupant, of a front pillar that serves as the vehicle structural part, and
the opening of the image projecting device is formed such that, of an image projected by the projecting unit, an image other than an image that is to be projected onto the projected-on surface is blocked by the interior fitting part.

10: The driving support device of claim 8, wherein
the projecting unit of the image projecting device is disposed between a front portion of a roof, and a ceiling material that serves as the interior fitting part and covers the roof from a vehicle cabin side, and
the opening of the image projecting device is formed in an erect wall that faces a vehicle front side at the ceiling material, and at least a portion of the opening is covered by an inner mirror when the vehicle cabin is viewed from a front side.
